(19) United States
(12) Patent Application Publication
(10) Pub. No.: US 2021/0206163 A1
(43) Pub. Date: Jul. 8, 2021

(54) DECORATIVE MEMBER MANUFACTURING APPARATUS AND METHOD FOR MANUFACTURING DECORATIVE MEMBER

(71) Applicant: FUJIFILM Corporation, Tokyo (JP)

(72) Inventor: Tomohiro MIZUNO, Kanagawa (JP)

(73) Assignee: FUJIFILM Corporation, Tokyo (JP)

(21) Appl. No.: 17/210,509

(22) Filed: Mar. 24, 2021

Related U.S. Application Data
(63) Continuation of application No. PCT/JP2019/032858, filed on Aug. 22, 2019.

(30) Foreign Application Priority Data
Sep. 27, 2018 (JP) 2018-181894

(51) Int. Cl. B41J 2/045

(52) U.S. Cl. CPC B41J 2/04508; B41J 2/04586

(57) ABSTRACT

Provided are a decorative member manufacturing apparatus and a method for manufacturing a decorative member, which are capable of adjusting the tactile sensation in each portion of a decorative layer image-wise so as to obtain a desired tactile sensation.

In a case of manufacturing a decorative member having a decorative layer formed on a surface of a base material, by a jetting part, a fluid cured by receiving light is jetted toward respective portions of the surface of the base material to form the decorative layer; by a scattering part, fine particles are scattered to the fluid which has landed on the respective portions; and by a control part, the jetting part and the scattering part are controlled, in which the control part controls at least one of the jetting part or the scattering part depending on a control condition set in association with the respective portions according to a setting content regarding tactile sensation of the decorative member.

### CROSS-REFERENCE TO RELATED APPLICATIONS

This application is a Continuation of PCT International Application No. PCT/JP2019/032858 filed on Aug. 22, 2019, which claims priority under 35 U.S.C. § 119(a) to Japanese Patent Application No. 2018-181894 filed on Sep. 27, 2018. The above application is hereby expressly incorporated by reference, in its entirety, into the present application.

### BACKGROUND OF THE INVENTION

### 1. Field of the Invention

The present invention relates to a decorative member manufacturing apparatus and a method for manufacturing a decorative member, and relates to a decorative member manufacturing apparatus and a method for manufacturing a decorative member, in which a decorative member having a decorative layer on a surface of a base material is manufactured using a fluid cured by receiving light, and fine particles.

### 2. Description of the Related Art

With the recent development of printing technique, the market for decorative members manufactured using digital printing technique is expanding. The decorative member has a decorative layer on a surface thereof. The decorative layer changes optically or has an uneven shape to express a settled texture. As an apparatus for manufacturing a decorative member having an unevenly shaped decorative layer, an inkjet printer and the like, in which a fluid, such as clear ink, cured by receiving light lands on a surface of a base material and the landed fluid is irradiated with light, has been known. In such an apparatus, the texture of the decorative layer can be adjusted by controlling the amount, type, and landing position of the fluid to be used, the irradiation intensity of light, and the like.

For example, an apparatus disclosed in JP5391494B (specifically, an image forming apparatus) includes a head which is mounted on a carriage capable of reciprocating in a scanning direction and jets UV-curable type ink, an irradiator which irradiates the UV-curable type ink jetted from the head with ultraviolet rays, and a controller to control the head and the irradiator. In the outward path of the carriage, the controller changes a jet amount to jet the UV-curable type ink from the head in a perforated state, and in the return path of the carriage, the controller causes the irradiator to irradiate ultraviolet rays. As a result, the smoothness of the UV-curable type ink on a recording medium can be made non-uniform depending on the location, in other words, a decorative layer having appropriate unevenness can be formed.

In addition, some of decorative members having an unevenly shaped decorative layer include a decorative layer containing fine particles. For example, a decorative member disclosed in JP5620613B (specifically, a surface decoration film) has a surface decorative layer, and the surface decorative layer contains a cured product of a curable resin compound, a predetermined cationic resin, and two or more kinds of inorganic fine particles that average particle size is adjusted to a predetermined range. The surface roughness of the surface decorative layer is adjusted within a predetermined numerical range (for example, 0.40 μm to 2.0 μm), and the surface decorative layer has an excellent smooth feeling.

### SUMMARY OF THE INVENTION

In order to increase the added value of the decorative member, it is necessary to adjust the texture of the final decorative layer, particularly the tactile sensation such as friction, unevenness degree, and bendability, so as to obtain a desired tactile sensation. For this purpose, in a case where the decorative layer is formed by a decorative member manufacturing apparatus, it is necessary to control the operating conditions of each part of the apparatus so that a desired tactile sensation can be obtained. In addition, it is preferable that the texture of each portion of the decorative layer can be adjusted image-wise according to the position of each portion of the decorative layer.

On the other hand, in the apparatus (image forming apparatus) disclosed in JP5391494B, although the smoothness of the UV-curable type ink in the decorative layer is non-uniform depending on the location, how to adjust the texture in each portion of the decorative layer has not been determined, and it is unclear whether the final texture will have the desired tactile sensation.

In addition, in the decorative member (surface decoration film) disclosed in JP5620613B, the surface decorative layer has an excellent smooth feeling, but the smooth feeling is not adjusted image-wise. In addition, in manufacturing the decorative member (surface decoration film) disclosed in JP5620613B, although the surface roughness and the like of the surface decorative layer is adjusted within a predetermined numerical range, it is unclear that such adjustment is performed to realize what kind of tactile sensation.

In analog printing in which printing is performed using a plate and ink, for example, it is possible to control the matte feeling and the like of printed article by using ink containing fine particles, but since it is necessary to prepare a plate for each ink, it is difficult to perform image-wise tactile sensation control in terms of cost and manufacturing time.

Therefore, the present invention has been studied in view of such circumstances, and an object of the present invention is to achieve the following objects.

Specifically, to solve the above-described problems of the prior art, an object of the present invention is to provide a decorative member manufacturing apparatus and a method for manufacturing a decorative member, which are capable of adjusting the tactile sensation in each portion of a decorative layer image-wise so as to obtain a desired tactile sensation.

In order to achieve the above-described object, a decorative member manufacturing apparatus according to an aspect of the present invention is a decorative member manufacturing apparatus for manufacturing a decorative member having a decorative layer formed on a surface of a base material, the decorative member manufacturing apparatus comprising:

a jetting part that jets a fluid toward respective portions of the surface of the base material to form the decorative layer, the fluid being cured by receiving light;

a scattering part that scatters fine particles to the fluid which has landed on the respective portions; and

a control part that controls the jetting part and the scattering part,

in which the control part controls at least one of the jetting part or the scattering part depending on a control condition set in association with the respective portions according to a setting content regarding tactile sensation of the decorative member.

In the decorative member manufacturing apparatus according to the aspect of the present invention configured as described above, at least one of the jetting part or the scattering part is controlled depending on a control condition set in association with the respective portions according to the setting content regarding tactile sensation of the decorative member. As a result, it is possible to adjust the tactile sensation in each portion of the decorative layer image-wise so as to obtain a desired tactile sensation.

In addition, with respect to the above-described decorative member manufacturing apparatus, it is more suitable that the control part controls the jetting part such that an amount of the fluid, which is set in association with the respective portions according to the setting content, lands on the respective portions.

With the above-described configuration, by controlling the amount of the fluid which has landed on the respective portions of the surface of the base material, it is possible to adjust the tactile sensation in each portion of the decorative layer.

In addition, with respect to the above-described decorative member manufacturing apparatus, the control part may control the jetting part such that the fluid of an amount which is set in association with the respective portions according to a setting content regarding an unevenness degree of the decorative layer lands on the respective portions.

With the above-described configuration, by controlling the amount of the fluid which has landed on the respective portions of the surface of the base material, it is possible to adjust the unevenness degree as a tactile sensation in each portion of the decorative layer.

In addition, with respect to the above-described decorative member manufacturing apparatus, it is more suitable that the control part controls the jetting part such that the fluid of a type which is set in association with the respective portions according to the setting content lands on the respective portions.

With the above-described configuration, by controlling the fluid of the type, which has landed on the respective portions of the surface of the base material, it is possible to adjust the tactile sensation in each portion of the decorative layer.

In addition, with respect to the above-described decorative member manufacturing apparatus, a stretching ratio of the fluid in a cured state may differ between fluids having different types from each other, and the control part may control the jetting part such that the fluid of a type and amount which are set in association with the respective portions according to a setting content regarding a bendability of the decorative member and an unevenness degree of the decorative layer lands on the respective portions.

With the above-described configuration, by controlling the fluid of the type and amount, which has landed on the respective portions of the surface of the base material, it is possible to adjust the bendability and unevenness degree as a tactile sensation in each portion of the decorative layer.

In addition, with respect to the above-described decorative member manufacturing apparatus, it is more suitable that the control part controls the scattering part such that the fine particles of an amount which is set in association with the respective portions according to a setting content regarding a magnitude of friction on a surface of the decorative layer adhere to the fluid which has landed on the respective portions.

With the above-described configuration, by controlling the amount of the fine particles adhering to the fluid at the respective portions of the surface of the base material, it is possible to adjust the magnitude of friction as a tactile sensation in each portion of the decorative layer.

In addition, with respect to the above-described decorative member manufacturing apparatus, a semi-curing part that semi-cures the fluid by irradiating the fluid which has landed on the respective portions with light may be further included, the scattering part may scatter the fine particles to the semi-cured fluid which has landed on the respective portions, the amount of the fine particles in the respective portions may increase as an amount of the semi-cured fluid in the respective portions increases, and the control part may control the jetting part and the semi-curing part such that the amount of the semi-cured fluid in the respective portions is an amount set in association with the respective portions according to the setting content regarding the magnitude of friction.

With the above-described configuration, by controlling the amount of the semi-cured fluid at the respective portions of the surface of the base material, the amount of the fine particles adhering to the fluid is controlled, and as a result, it is possible to adjust the magnitude of friction as a tactile sensation in each portion of the decorative layer.

In addition, with respect to the above-described decorative member manufacturing apparatus, a main curing part that irradiates the fluid which has landed on the respective portions with light to main-cure the fluid, and a moving mechanism for moving the base material between a first position where the surface of the base material faces the jetting part and a second position where the surface of the base material faces the scattering part may be included, and the following steps may be repeated multiple times to form the decorative layer, a jetting step in which the jetting part jets the fluid toward the surface of the base material while the base material is in the first position, a first moving step in which the moving mechanism causes the base material to move from the first position to the second position, a scattering step in which the scattering part scatters the fine particles to the fluid while the base material is in the second position, a main curing step in which the main curing part irradiates the fluid with light to main-cure the fluid while the base material is in the second position, and a second moving step in which the moving mechanism causes the base material to return from the second position to the first position.

With the above-described configuration, the decorative layer is formed by repeating the jet of the fluid, the scattering of the fine particles, and the main curing of the fluid multiple times.

In addition, with respect to the above-described decorative member manufacturing apparatus, in each time of the scattering steps, the control part may cause the scattering part to scatter the fine particles of an amount determined for each time of the scattering steps, such that the amount of the fine particles adhering to the fluid which has landed on the respective portions in multiple times of the scattering steps is an amount set in association with the respective portions according to the setting content regarding the magnitude of friction.

With the above-described configuration, in a case where the decorative layer is formed by repeating the scattering of the fine particles multiple times, by adjusting the amount of the fine particles scattered each time, it is possible to adjust the tactile sensation in each portion of the decorative layer (specifically, the magnitude of friction).

In addition, with respect to the above-described decorative member manufacturing apparatus, in each time of the scattering steps, the control part may cause the scattering part to scatter the fine particles to the fluid which has landed on the respective portions, the fine particles of a type set in association with the respective portions according to the setting content regarding the magnitude of friction, and a friction coefficient of the fine particles may differ between fine particles having different types from each other.

With the above-described configuration, in a case where the decorative layer is formed by repeating the scattering of the fine particles multiple times, by adjusting the type of the fine particles scattered each time, it is possible to adjust the tactile sensation in each portion of the decorative layer (specifically, the magnitude of friction).

In addition, with respect to the above-described decorative member manufacturing apparatus, the control part may control the scattering part such that the fine particles, which have a type set in association with the respective portions according to a setting content regarding a temperature of the decorative layer, adhere to the fluid which has landed on the surface of the base material, and a thermal conductivity of the fine particles may differ between fine particles having different types from each other.

With the above-described configuration, by controlling the type of the fine particles adhering to the fluid at the respective portions of the surface of the base material, it is possible to adjust the temperature (warmth and coldness) as a tactile sensation in each portion of the decorative layer.

In addition, in order to achieve the above-described object, a method for manufacturing a decorative member according to an aspect of the present invention is a method for manufacturing a decorative member having a decorative layer formed on a surface of a base material, the method comprising: a step of jetting, by a jetting part, a fluid cured by receiving light toward respective portions of the surface of the base material to form the decorative layer; a step of scattering, by a scattering part, fine particles to the fluid which has landed on the respective portions; and a step of setting a control condition in a case of controlling, by a control part, at least one of the jetting part or the scattering part in association with the respective portions according to a setting content regarding tactile sensation of the decorative member.

According to the above-described method, in a case of manufacturing a decorative member having a decorative layer on the surface thereof, it is possible to adjust the tactile sensation in each portion of the decorative layer to a desired tactile sensation image-wise.

According to the present invention, a decorative member manufacturing apparatus and a method for manufacturing a decorative member, which are capable of adjusting the tactile sensation in each portion of the decorative layer image-wise so as to obtain a desired tactile sensation, are realized.

### BRIEF DESCRIPTION OF THE DRAWINGS

FIG. 1 is a conceptual diagram showing a configuration of a decorative member manufacturing apparatus according to an embodiment of the present invention.

FIG. 2 is a schematic diagram showing a mechanical configuration of an inkjet printer.

FIG. 3 is a diagram showing a nozzle surface of a jetting part.

FIG. 4 is a plan view showing an example of a decorative member.

FIG. 5 is a diagram showing setting contents of tactile sensation for each pattern of the decorative layer shown in FIG. 4 and control conditions in a case of forming patterns.

FIG. 6 is a schematic cross-sectional view showing how each pattern is formed (No. 1).

FIG. 7 is a schematic cross-sectional view showing how each pattern is formed (No. 2).

FIG. 8 is a schematic cross-sectional view showing how each pattern is formed (No. 3).

FIG. 9 is a diagram showing a relationship between a proportion of highly stretched ink and bendability of a decorative member.

FIG. 10 is a schematic cross-sectional view showing how each pattern is formed (No. 4).

FIG. 11 is a schematic cross-sectional view showing how each pattern is formed (No. 5).

FIG. 12 is a schematic cross-sectional view showing how each pattern is formed (No. 6).

FIG. 13 is a schematic cross-sectional view showing how each pattern is formed (No. 7).

FIG. 14 is a schematic cross-sectional view showing how each pattern is formed (No. 8).

FIG. 15 is a diagram showing a relationship between a landing amount of clear ink and a magnitude of friction on a surface of a decorative layer.

FIG. 16 is an explanatory diagram of tactile sensation control by a combination of a type of a base material and a decorative layer (No. 1).

FIG. 17 is an explanatory diagram of tactile sensation control by a combination of a type of a base material and a decorative layer (No. 2).

### DESCRIPTION OF THE PREFERRED EMBODIMENTS

Hereinafter, a decorative member manufacturing apparatus and method for manufacturing a decorative member according to an embodiment of the present invention (present embodiment) will be described in detail with reference to suitable embodiments shown in the accompanying drawings.

It should be noted that the embodiments described below are merely examples for facilitating the understanding of the present invention, and do not limit the present invention. That is, the present invention can be modified or improved from the embodiments described below without departing from the spirit of the present invention. In addition, understandably, the present invention includes an equivalent thereof.

In addition, in the present specification, a numerical range represented using “to” means a range including numerical values described before and after the preposition “to” as a lower limit value and an upper limit value.

In addition, in the present specification, “%” and “part” that represent the content rate and the amount used are mass-based unless particularly otherwise described.

In addition, in the present specification, “portion” is a broader concept than “area (unit area)”, and specifically, one portion is configured by arranging a plurality of areas (unit areas) so as to form a predetermined shape (for example, a rectangle or a square).

[Decorative Member Manufacturing Apparatus]

A decorative member manufacturing apparatus 10 of the present embodiment is a decorative member manufacturing apparatus in which a decorative member having a decorative layer formed on a surface of a base material is manufactured, and is an apparatus for manufacturing a decorative member using color ink, clear ink as a fluid, and fine particles described later. The decorative member is manufactured by forming a decorative layer constituted of color ink and clear ink on the surface of the base material, and the decorative layer imparts a predetermined texture (tactile sensation) to the decorative member.

In the present embodiment, the tactile sensation of the decorative member is a property that, among qualities of the decorative member, can be felt by a human tactile sensation (for example, a hand and a finger). Specific examples of the tactile sensation of the decorative member include bendability (in other words, hardness or stretchability) of the decorative member, unevenness degree of the decorative layer, magnitude of friction on a surface of the decorative layer, and temperature (in other words, warmth and coldness) of the decorative layer. However, the above-described tactile sensation is merely an example, tactile sensation other than the above may be included as the tactile sensation of the decorative member.

The decorative layer is formed by superimposing a clear ink image formed by the clear ink on a color ink image printed by the color ink on the surface of the base material, and further adhering fine particles to the surface of the clear ink image.

As the base material, papers such as printing paper, for example, coated paper and non-coated paper, an information paper, a wrapping paper, and a paperboard; resin films (for example, plastic films) and sheets; and wooden, glass, ceramic, metal, or resin boards and panels are available. The papers, films, and sheets may be supplied in a state of being cut into a single sheet, or may be supplied in a state of being rolled into a roll.

To add to the procedure for forming the decorative layer, it is not limited to the case where the clear ink image is superimposed on the color ink image, but the clear ink image may be formed first, and then the color ink image may be recorded (printed) on the clear ink image. In addition, instead of forming each of the color ink image and the clear ink image separately, using colored UV-curable type ink or the like, the color ink image and the clear ink image may be integrally (simultaneously) formed.

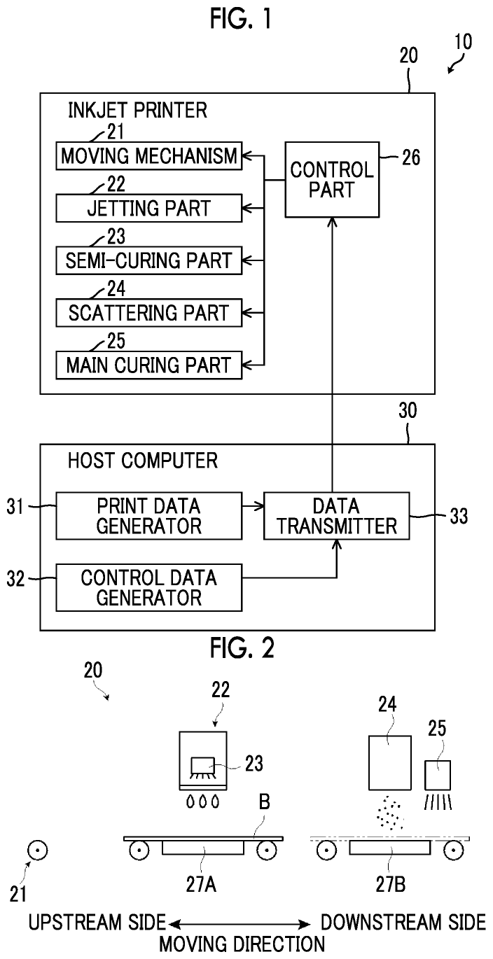

Explaining the configuration of the decorative member manufacturing apparatus 10 of the present embodiment, as shown in FIG. 1, the decorative member manufacturing apparatus 10 includes an inkjet printer 20 and a host computer 30 as main constituent devices. FIG. 1 is a conceptual diagram showing the configuration of the decorative member manufacturing apparatus 10 of the present embodiment. Each of the inkjet printer 20 and the host computer 30 will be described below.

<Inkjet Printer>

The inkjet printer 20 is an apparatus for forming the decorative layer on the surface of the base material. Specifically, the inkjet printer 20 jets the color ink and the clear ink toward the surface of the base material, cures the clear ink landed on the surface of the base material, and scatters fine particles to the cured clear ink.

As shown in FIGS. 1 and 2, the inkjet printer 20 has a moving mechanism 21, a jetting part 22, a semi-curing part 23, a scattering part 24, a main curing part 25, and a control part 26. FIG. 2 is a diagram showing a mechanical configuration of the inkjet printer 20.

The moving mechanism 21 causes the base material (hereinafter, referred to as a base material B) to move along a moving path in the inkjet printer 20. The moving mechanism 21 may be configured of a drive roller as shown in FIG. 2, or may be configured of a drive belt.

In addition, as shown in FIG. 2, two platens 27A and 27B are disposed on an intermediate position of the moving path of the base material B. One platen 27A is disposed on the upstream side (closer to a supply port of the base material B in the inkjet printer 20) in the moving path of the base material B. In a case where the base material 13 is placed on the platen 27A, the surface (strictly, surface for forming the decorative layer) of the base material B faces the lower surface (nozzle surface) of the jetting part 22. That is, the position where the base material B is placed on the platen 27A (the position of the base material B drawn by the solid line in FIG. 2) corresponds to the position where the surface of the base material B faces the jetting part 22. Hereinafter, it is referred to as a first position.

The other platen 27B is disposed on the downstream side (closer to an exhaust port of the base material B in the inkjet printer 20) in the moving path of the base material B. In a case where the base material B is placed on the platen 27B, the surface (that is, surface on which the color ink and the clear ink land) of the base material B faces the scattering part 24. That is, the position where the base material B is placed on the platen 27B (the position of the base material B drawn by the two-dot chain line in FIG. 2) corresponds to the position where the surface of the base material B faces the scattering part 24. Hereinafter, it is referred to as a second position.

In addition, in the present embodiment, the moving step of the base material B by the moving mechanism 21 is performed intermittently (fitfully). That is, every time the base material B moves by a predetermined distance, the movement of the base material B is halted, and after a certain period of time, the base material B moves again by a predetermined distance, and thereafter, the same operation is repeated.

In order to form the decorative layer on the base material B, the jetting part 22 jets the color ink and the clear ink toward the surface of the base material while the base material B is in the first position. The color ink is a colored ink containing a pigment or a dye, and is a general ink used for color printing and the like. The clear ink is a UV-curable type fluid cured by receiving light (specifically, ultraviolet rays). The fluid used to form the decorative layer in the present invention may be any fluid which can be cured by being irradiated with light. In addition, examples of the irradiation light include ultraviolet rays, infrared rays, and visible light. In addition, the fluid of the present invention is a composition including at least a polymerizable compound and a photoinitiator as main components, and examples thereof include a cationic polymerization type ink composition, a radical polymerization type ink composition, and an aqueous ink composition.

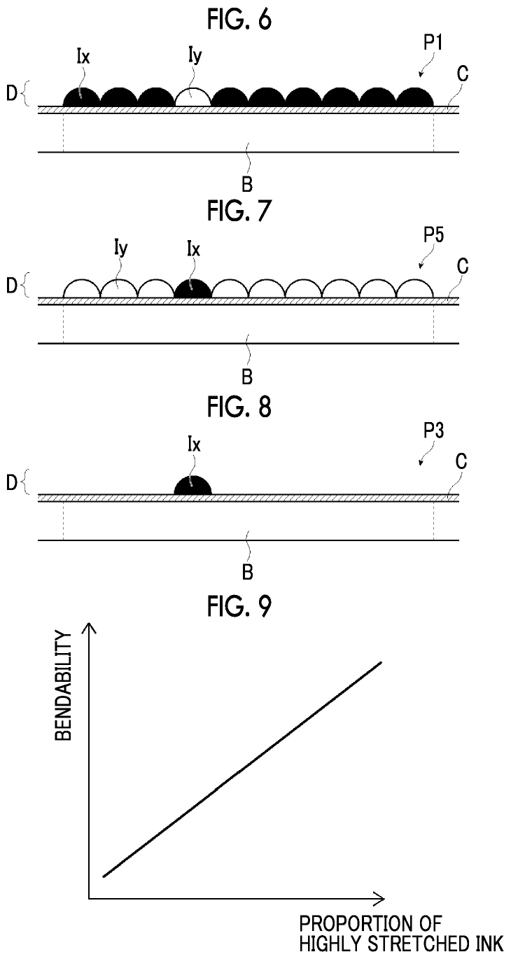

The color ink jetted from the jetting part 22 lands on a unit area on the surface of the base material to form dots. Here, the unit area is a unit that constitutes an image forming area on the surface of the base material, and is a square area corresponding to a pixel of an image to be printed. The dots of each color ink which has landed on the surface of the base material form halftone dot images, and each halftone dot image of Y (yellow), M (magenta), C (cyan), and K (black) is formed. As a result, a four-color full-color ink image (for example, a color ink image C shown in FIG. 6 and the like) is printed on the surface of the base material.

The clear ink jetted from the jetting part 22 lands on the color ink image in respective portions on the surface of the base material to form dots. Thereafter, the landed clear ink dots are cured by receiving ultraviolet rays. Then, by the cured clear ink dots, a clear ink image (for example, a clear ink image D shown in FIG. 6 and the like) is formed while being superimposed on the color ink image.

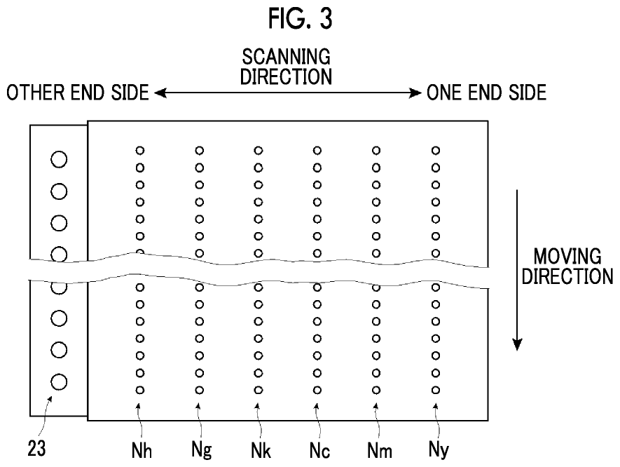

In the present embodiment, the jetting part 22 is constituted of a recording head which jets each ink by driving a piezo element, and forms the color ink image and the clear ink image on the surface of the base material by a shuttle scan method. More specifically, as shown in FIG. 3, on the lower surface (nozzle surface) of the jetting part 22, a plurality of nozzles arranged in a row along the moving direction of the base material B are provided for each type of ink. FIG. 3 is a diagram showing the nozzle surface of the jetting part 22.

More specifically, on the nozzle surface, in order from one end side along the scanning direction of the jetting part 22, a row of yellow ink nozzles Ny, a row of magenta ink nozzles Nm, a row of cyan ink nozzles Ne, and a row of black ink nozzles Nk are arranged. Furthermore, two rows of clear ink nozzles Ng and Nh are arranged on the other end side in the scanning direction.

In the present embodiment, each of the rows of the two clear ink nozzles Ng and Nh jets different types of clear ink. The stretching ratio of the clear ink in a cured state differs between clear inks having different types from each other. Clear ink (highly stretched ink) having a higher stretching ratio is jetted from one clear ink nozzle Ng. Clear ink (low-stretched ink) having a lower stretching ratio is jetted from the other clear ink nozzle Nh. As the highly stretched ink, for example, a highly stretched ink (trade name: Uvijet KV ink) manufactured by FUJIFILM Corporation is available, and as the low-stretched ink, known clear inks sold as ordinary inks are available.

The stretching ratio is measured by, for example, the following measuring method described in WO2013/027672A.

(Measuring Method of Stretching Ratio)

An ink composition is applied to a polycarbonate plate (thickness: 0.5 mm) with a #12 bar coater to form a coating film having a thickness of 20 μm. This coating film is irradiated with ultraviolet rays from a UV lamp (Z-8 lamp) manufactured by Heraeus under irradiation conditions of 120 W/cm×23 m/min and a distance of 10 cm (integrated light amount per 1 pass is 60 mJ/cm²), so that the coating film is cured until it is completely cured. After curing, the cured coating film is cut out to a size of 2 cm×10 cm to produce a measurement sample piece, and the measurement sample piece is stretched at a tensile speed of 50 mm/min in an environment of 180° C. by a tensile tester. The stretching ratio is measured by the length at which the cured coating film can be stretched without cracking. Specifically, in a case where the distance between black spots at the center of the measurement sample piece, which are marked so as to sandwich the center, changes from 1 cm before stretching to X cm due to stretching, the stretching ratio is obtained by the following expression.

Stretching ratio={(X−1)/1}×100

The number of types of clear ink is not particularly limited and can be set to any number. In addition, in the case shown in FIG. 3, one nozzle row is provided for each type of clear ink, but the present invention is not limited thereto. A plurality of nozzle rows may be provided for each type of clear ink.

In addition, the method of jetting ink from the jetting part 22 is not limited to the method of using a piezo element. Various methods such as a thermal jet method in which ink is heated by a heating element such as a heater to generate bubbles and ink droplets are blown by the pressure can be applied.

In addition, in the present embodiment, the jetting part 22 is configured of a serial type head and prints by the shuttle scan method, but the present invention is not limited thereto. For example, the jetting part 22 may be configured of a full-line type head, and may print by a single-pass method.

In addition, in the present embodiment, both the color ink nozzle and the clear ink nozzle are formed on the same nozzle surface, but the present invention is not limited thereto. For example, the jetting part 22 may have two recording heads disposed on positions separated from each other in the moving direction of the base material B, and a color ink nozzle may be formed on the lower surface of the recording head on the upstream side and a clear ink nozzle may be formed on the lower surface of the recording head on the downstream side. Furthermore, the recording heads on which the color ink nozzles are formed may be provided separately for each ink color.

While the base material B is in the first position, the semi-curing part 23 irradiates the clear ink dots which have landed on the respective portions of the surface of the base material with light, strictly, ultraviolet rays to semi-cure the clear ink dots. That is, the semi-curing part 23 irradiates ultraviolet rays with an irradiation intensity at a level at which the clear ink dots are semi-cured. The semi-curing is a state in which the clear ink is not completely cured but is cured to the extent that the dot shape can be maintained (that is, the flow does not spread). As the semi-curing part 23, a metal halide lamp, a high-pressure mercury lamp, an ultraviolet light emitting diode (LED), and the like can be used.

In addition, in the present embodiment, the semi-curing part 23 is attached to the side of the jetting part 22. Specifically, the semi-curing part 23 is fixed to the jetting part 22 on the other end side of the clear ink nozzles Ng and Nh in the scanning direction (the side opposite to the side where the color ink nozzles are arranged in a case of viewing from the clear ink nozzles). That is, the semi-curing part 23 moves in the scanning direction together with the jetting part 22. Then, in one scanning operation of the jetting part 22, the semi-curing part 23 irradiates the surface of the base material with ultraviolet rays immediately after the clear ink is jetted from the clear ink nozzles Ng and Nh. As a result, the clear ink dots that have landed on the surface of the base material immediately receive ultraviolet rays and are semi-cured.

The present invention is not limited to the case where the semi-curing part 23 is fixed to the jetting part 22 and integrated with the jetting part 22, and the semi-curing part 23 may be separated from the jetting part 22. In addition, the disposed position of the semi-curing part 23 is not particularly limited. For example, the semi-curing part 23 may be disposed on the side end portion of the platen 27A and may irradiate ultraviolet rays from the side of the base material B.

In order to form the decorative layer on the base material B, the scattering part 24 scatters fine particles to the clear ink dots which have landed on the respective portions of the surface of the base material while the base material B is in the second position. Here, in a case where the base material B is in the second position, the clear ink dots are semi-cured by receiving the ultraviolet rays irradiated from the semi-curing part 23. Therefore, the scattering part 24 scatters fine particles to the semi-cured clear ink dots which have landed on the respective portions of the surface of the base material. The surface of the clear ink dots in the semi-cured state has adhesiveness, and the scattered fine particles adhere to the surface of the clear ink dots.

The scattering part 24 is provided with a plurality of holes (not shown) on the lower surface thereof. The fine particles are sprayed from each hole together with compressed air. That is, the scattering part 24 scatters the fine particles to the clear ink dots in the portion of the surface of the base material positioned below the holes. The fine particles may be sprayed as a mixture in a state of being mixed with a solvent consisting of a resin agent.

In addition, in the present embodiment, the scattering part 24 can scatter a plurality of types of fine particles. Furthermore, in the present embodiment, the types of fine particles sprayed from each hole can be set for each hole. That is, in the present embodiment, the type of fine particles adhering to the clear ink dots in the respective portions of the surface of the base material can be changed according to the portion of the surface of the substrate.

Here, the friction coefficient of the fine particles differs between fine particles having different types from each other. Specifically, the fine particles sprayed by the scattering part 24 in the present embodiment include polyethylene particles having a smaller friction coefficient and acrylic particles having a larger friction coefficient.

The polyethylene particles are fine particles of a polyethylene-based resin, and the friction coefficient thereof is 0.08 to 0.18. The polyethylene-based resin means an ethylene homopolymer or a copolymer including an ethylene monomer as a main component and the other monomer component copolymerizable with the ethylene monomer. In addition, the fact that the ethylene monomer is the main component means that the ethylene monomer occupies 50 parts by mass or more in 100 parts by mass of all the monomer components. Furthermore, the ethylene homopolymer means that the ethylene monomer occupies 92 parts by mass or more in 100 parts by mass of all the monomer components.

Examples of the polyethylene-based resin include polyethylene-based resins such as a branched low-density polyethylene, a linear low-density polyethylene, a medium-density polyethylene, a high-density polyethylene, an ethylene-propylene copolymer, and an ethylene-vinyl acetate copolymer. In order to obtain desired physical properties more easily, a linear low-density polyethylene or an ethylene-vinyl acetate copolymer is preferable as the polyethylene-based resin. In addition, the polyethylene-based resin may be used alone or in combination of two or more as long as it does not affect the desired physical properties. In addition, in a case where a copolymer is used as the polyethylene-based resin, the copolymer may be a random copolymer or a block copolymer.

The acrylic particles are fine particles obtained from an acrylic compound, and the friction coefficient thereof is approximately 0.38. The acrylic compound may be constituted of 30% by weight or more of a monomer such as acrylic acid and a salt thereof, and methacrylic acid and a salt thereof. At this time, one homopolymer or a copolymer consisting of two or more kinds of monomers may be used. Specific examples of the acrylic acid monomer include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, neopentyl (meth)acrylate, ethylhexyl (meth)acrylate, isodecyl acrylate, lauryl (meth)acrylate, tridecyl (meth)acrylate, stearyl (meth)acrylate, benzyl (meth)acrylate, tetrahydrofurfuryl (meth)acrylate, methoxyethyl (meth)acrylate, dimethylaminoethyl (meth) acrylate, chloroethyl (meth)acrylate, trifluoroethyl (meth)acrylate, heptadecafluorooctylethyl (meth)acrylate, isobornyl (meth)acrylate, adamantyl (meth)acrylate, and tricyclodecynyl (meth)acrylate.

In addition, a copolymerization component can be introduced into the above-described acrylic compound, and for example, a styrene-based monomer or the like can be used. At this time, the copolymerization amount can be any amount of 70 mol % or less.

In addition, in a case where a copolymer is used as the acrylic compound, the form thereof may be a block copolymer, a random copolymer, a graft copolymer, or any copolymer obtained by a combination thereof.

The friction coefficient is measured by, for example, the following measuring method disclosed in JP5620613B.

(Measuring Method of Friction Coefficient)

The friction coefficient (surface friction coefficient) is measured using a friction tester (KES-SE) manufactured by KATO TECH CO., LTD. As the measurement conditions, a standard friction block bar is used, a silicon sensor (10 mm×10 mm×3 mm) manufactured by KATO TECH CO., LTD. is used for the friction block, a load in a case of friction is set to 0.245 N/cm² (25 gf/cm²), and a measurement sensitivity is set to be H (sensitivity: 20 g/V). The friction distance, friction speed, and other conditions are as specified in the apparatus (specifically, the friction distance is set to 30 mm, the analysis distance is set to 20 mm, and the sample moving speed is set to 1 mm/sec, and the like). Then, a data logger (multi-input data acquisition system manufactured by KEYENCE CORPORATION) is connected to the friction tester, the voltage value of the load obtained at the measurement is acquired, and the friction coefficient is defined as a voltage value immediately before a timing at which the friction block starts to move. The measurement may be performed in an environment of 20° C. and 65% relative humidity (RH), and the average value of 5 measurements may be adopted.

While the base material B is in the second position, the main curing part 25 irradiates the clear ink dots in the semi-cured state with ultraviolet rays to main-cure the clear ink dots. As shown in FIG. 2, the main curing part 25 is positioned slightly downstream side of the scattering part 24 in the moving direction of the base material B, and irradiates ultraviolet rays with an irradiation intensity at a level at which the semi-cured clear ink dots are main-cured. As a result, the clear ink dots to which the fine particles adhere are main-cured while the fine particles are held and supported on the surface thereof.

As the main curing part 25, a metal halide lamp, a high-pressure mercury lamp, an ultraviolet light emitting diode (LED), and the like can be used.

In addition, the disposed position of the main curing part 25 is not particularly limited. For example, the main curing part 25 may be disposed on the side end portion of the platen 27B and may irradiate ultraviolet rays from the side of the base material B.

The control part 26 is a controller built in the inkjet printer 20, and controls each of the moving mechanism 21, the jetting part 22, the semi-curing part 23, the scattering part 24, and the main curing part 25 through a drive circuit. Specifically, in a case where the control part 26 receives an instruction for manufacturing a decorative member sent from the host computer 30, the control part 26 controls the moving mechanism 21 to intermittently move the base material B set at a predetermined position of the inkjet printer 20 along the moving direction.

In addition, the control part 26 controls the jetting part 22 according to print data and control data while the base material B is in the first position, and various types of ink are jetted from the jetting part 22. The print data is data sent from the host computer 30 together with the instruction for manufacturing a decorative member, and defines a jet amount of the color ink (in other words, the size of the color ink dots), a landing position (dot formation position) on the surface of the base material, and the like.

The control data is data sent from the host computer 30 together with the instruction for manufacturing a decorative member, and defines the type of the clear ink, the jet amount of the clear ink, and the like for the respective portions on the surface of the base material. In addition, the control data defines the above-described types of the fine particles, the amount of scattering, the spraying timing, and the like for the respective portions of the surface of the base material.

The control data will be described in detail later.

The jetting part 22 jets color inks of each color from the nozzles Ny, Nm, Nc, and Nk toward the surface of the base material under the control of the control part 26 while moving in the scanning direction. As a result, the color ink dots of each color are formed on the surface of the base material at the portions facing the nozzles Ny, Nm, Nc, and Nk. As a result, a four-color full-color ink image is formed on the surface of the base material.

In addition, the jetting part 22 jets the clear inks from the clear ink nozzles Ng and Nh after jetting the color inks in one ink jetting step. At this time, the control part 26 controls the jetting part 22 according to the control data. Under such control, the jetting part 22 jets, toward the respective portions on the surface of the base material, clear ink having the type and jet amount corresponding to the respective portions. That is, in the present embodiment, it is possible that the control part 26 controls the jetting part 22 depending on the control data to control the type and jet amount of the clear ink in an image-wise manner according to the respective portions on the surface of the base material.

In addition, the control part 26 controls the semi-curing part 23 to irradiate ultraviolet rays from the semi-curing part 23, immediately after the clear ink is jetted from the jetting part 22. As a result, the clear ink dots which have landed on the surface of the base material are immediately semi-cured.

Thereafter, in a case where the moving mechanism 21 further moves the base material B so that the base material B reaches the second position, the control part 26 controls the scattering part 24 according to the control data. Under such control, the scattering part 24 scatters, to the clear ink dots which have landed on the respective portions on the surface of the base material, fine particles having the type and scatter amount corresponding to the respective portions. More specifically, from the holes formed in the lower surface of the scattering part 24, which is positioned directly above the respective portions on the surface of the base material, the type and amount of fine particles corresponding to the respective portions are sprayed. That is, in the present embodiment, it is possible that the control part 26 controls the scattering part 24 depending on the control data to control the type and the scatter amount (in other words, adhesion amount) of the fine particles in an image-wise manner according to the respective portions on the surface of the base material.

In addition, during the base material B is in the second position and after the scattering part 24 has scattered the fine particles, the control part 26 controls the main curing part 25 to irradiate ultraviolet rays from the main curing part 25. As a result, the clear ink dots, which have been in the semi-cured state until then, are main-cured.

As described above, the operation of each part of the inkjet printer 20, that is, the moving step of the base material B by the moving mechanism 21, the jetting step of the color ink and the clear ink by the jetting part 22, the semi-curing step of the clear ink by the semi-curing part 23, the scattering step of the fine particles by the scattering part 24, and the main curing step of the clear ink by the main curing part 25 are respectively performed under the control of the control part 26. As a result, a decorative layer is formed on the surface of the base material, and the decorative member is completed. The completed decorative member moves to the exhaust port of the inkjet printer 20 by the moving mechanism 21, and is finally exhausted from the exhaust port.

<Host Computer>

The host computer 30 is communicably connected to the inkjet printer 20, and executes a program such as an application program for manufacturing a decorative member and a printer driver. The printer driver converts data (image data) of image generated by the application program for manufacturing a decorative member into the above-described print data.

In addition, the printer driver generates the above-described control data according to the above-described image data and the content of the tactile sensation set by a user (manufacturer of the decorative member) in a case of executing the application program for manufacturing a decorative member. The setting content of the tactile sensation is content set by the user regarding the tactile sensation (texture) of the decorative member as a final product. In the present embodiment, the setting content is determined by selecting one candidate from a plurality of preset candidates.

The printer driver may be recorded on a recording medium, such as an optical disk, which can be read by the host computer 30, or may be downloadable to the host computer 30 through a communication network such as Internet.

As shown in FIG. 1, the host computer 30 has a print data generator 31, a control data generator 32, and a data transmitter 33.

The print data generator 31 receives the image data from the application program for manufacturing a decorative member, and generates the print data from the image data. The image data is color image data indicating the original image of the color ink image C formed on the surface of the base material. The print data generator 31 executes resolution conversion processing, color conversion processing, halftone processing, and rasterization processing on the received image data.

The resolution conversion processing is a process of converting the image data into a resolution reproducible by the inkjet printer 20, and specifically, converting the image data into data showing each gradation value (specifically, a value of 0 to 255) of red (R), green (G), and blue (B). In the color conversion processing, with reference to a color conversion look-up table (not shown), the colors indicated by the resolution-converted image data (that is, RGB tri-color) are converted into colors of ink which can be jetted by the inkjet printer 20 (that is, YMCK four-color). The halftone processing is a process of converting the image data converted to gradation values of each YMCK color by the color conversion processing into color ink dot size data formed on each pixel. The rasterization processing is a process of dividing the halftone-processed image data into pixel units, and rearranging the pixel units in the order in which the pixel units will be transferred to the inkjet printer 20.

The control data generator 32 receives, from the application program for manufacturing a decorative member, the setting content regarding the image data and the tactile sensation, and generates the control data based thereon. As described above, the control data is data for controlling, in association with the respective portions on the surface of the base material, the type and jet amount of the clear ink to be jetted toward the respective portions on the surface of the base material, and the type and scatter amount of the fine particles to be scattered to the respective portions on the surface of the base material. In this respect, it can be said that the control data is data for controlling the tactile sensation of the decorative member in an image-wise manner according to the respective portions on the surface of the base material.

The data transmitter 33 transmits the print data generated by the print data generator 31 and the control data generated by the control data generator 32 to the inkjet printer 20 together with the manufacturing instruction of the decorative member.

[Regarding Generation Procedure of Control Data]

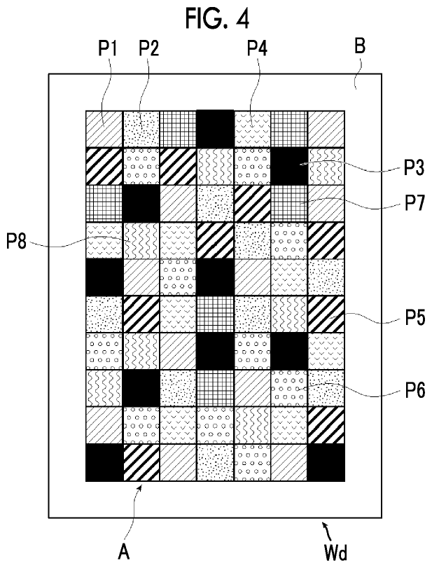

Hereinafter, the generation procedure of the control data will be described in detail, and for the purpose of making the explanation easy to understand, a case for manufacturing a decorative member shown in FIG. 4 (hereinafter, a decorative member Wd) will be described as an example. FIG. 4 is a plan view showing the decorative member Wd as an example of the decorative member.

Explaining the decorative member Wd first, in the decorative member Wd, a decorative layer A shown in FIG. 4 is formed on the surface of the base material B. The decorative layer A is configured by arranging eight types of rectangular patterns P1 to P8 in a grid shape. That is, the decorative layer A of FIG. 4 is divided into a plurality of rectangular portions, and is configured by assigning any one of eight types of the patterns P1 to P8 to each portion.

The type of pattern, the shape of the pattern, and the like constituting the decorative layer A are not particularly limited and can be arbitrarily determined.

The shapes and sizes of each of the patterns P1 to P8 are uniform among the patterns. On the other hand, the tactile sensations of each of the patterns P1 to P8 are different between the patterns. More specifically, a combination of bendability of the decorative member Wd (hereinafter, simply referred to as “bendability), unevenness degree of the decorative layer A (hereinafter, simply referred to as “unevenness degree”), and magnitude of friction on the surface of the decorative layer A (hereinafter, simply referred to as “magnitude of friction”) is different between the patterns.

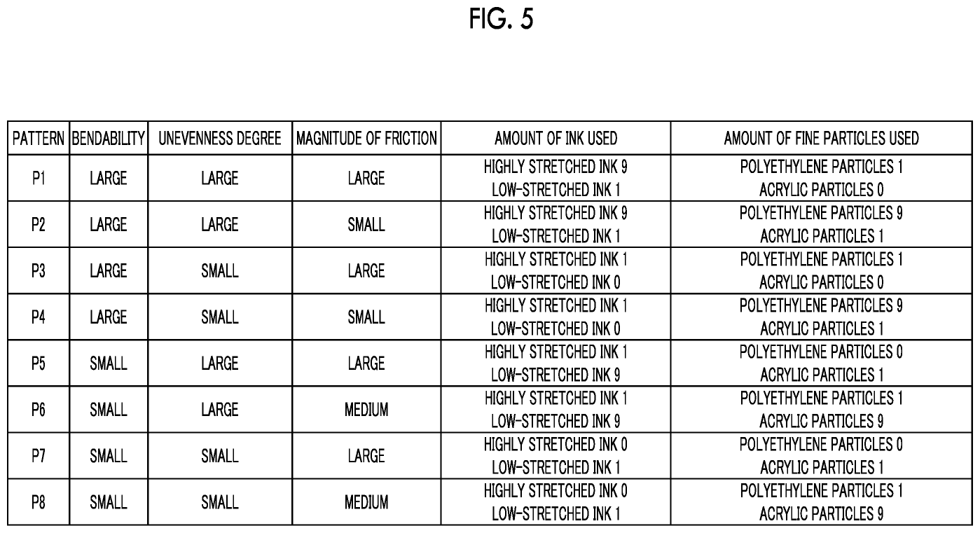

In order to generate the control data for forming the above decorative layer A on the surface of the base material, first, the user starts the application program for manufacturing a decorative member, and through the program, the tactile sensation is set for each of the eight types patterns P1 to P8. Specifically, as shown in FIG. 5, the bendability, the unevenness degree, and the magnitude of friction are set for each of the patterns P1 to P8. FIG. 5 is a diagram showing setting contents of tactile sensation for each of the patterns P1 to P8 and control conditions in a case of forming patterns.

Explaining a specific method of setting the tactile sensation, the bendability is represented by the degree of deformation (amount of deformation) in a case where a predetermined force is applied, and the bendability is larger as the amount of deformation is larger. Therefore, in the present embodiment, for example, either “large” or “small” is selected in a case of setting the bendability.

The unevenness degree is represented by the frequency of appearance of unevenness, and the unevenness degree is larger as the unevenness appears more frequently. Therefore, in the present embodiment, for example, either “large” or “small” is selected in a case of setting the unevenness degree.

The magnitude of friction is the difficulty of slipping on the surface, and the magnitude of friction is larger as the surface is less slippery. Therefore, in the present embodiment, for example, one of “large”, “medium”, or “small” is selected in a case of setting the magnitude of friction.

More specifically, in the case shown in FIG. 5 as an example, for the pattern P1, the bendability is set to “large”, the unevenness degree is set to “large”, and the magnitude of friction is set to “large”. In addition, for the pattern P6, the bendability is set to “small”, the unevenness degree is set to “large”, and the magnitude of friction is set to “medium”.

By the way, the method of setting each tactile sensation is not limited to the above-described method, and for example, may be set by inputting a specific numerical value.

After setting the tactile sensation of each of the patterns P1 to P8, the user assigns any one of the eight types of patterns P1 to P8 to each of the plurality of portions constituting the decorative layer A. As a result, the tactile sensation at the respective portions of the decorative layer A is set.

Next, the control data generator 32 of the host computer 30 determines conditions for forming the patterns P1 to P8 according to the contents of the tactile sensation of each of the patterns P1 to P8, which are set by the user. Specifically, the control data generator 32 refers to a tactile sensation conversion look-up table (not shown) and sets control conditions according to the setting contents of the tactile sensation for each of the patterns P1 to P8 for each pattern (in other words, in association with the respective portions on the surface of the base material).

Here, the control condition is a control condition in a case where the control part 26 controls each of the jetting part 22 and the scattering part 24 in order to form each of the patterns P1 to P8. Specifically, the type, amount, and the like of the clear ink to be jetted from the jetting part 22, and the type, amount, and the like of the fine particles to be scattered from the scattering part 24 correspond to the control conditions. For example, as a control condition for forming the pattern P1, the type and jet amount of the clear ink, and the type and scatter amount of the fine particles for realizing the setting content (that is, the bendability, the unevenness degree, and the magnitude of friction are all “large”) of the tactile sensation for the pattern P1 are determined. Specifically, as shown in FIG. 5, the jet amount of the highly stretched ink is set to 9, the jet amount of the low-stretched ink is set to 1, the scatter amount of the polyethylene particles is set to 1, and the scatter amount of the acrylic particles is set to 0. Here, “1”, “9”, and “0” as numerical values indicating the jet amount and the scatter amount represent multiples to a specified amount, respectively.

Then, after the control conditions are set for each of the eight types of the patterns P1 to P8, the control data generator 32 generates control data based on the pattern type assigned to the respective portions of the decorative layer A and the set control conditions for each pattern. As described above, the control data obtained in this way is data for controlling the tactile sensation of the decorative member Wd in an image-wise manner according to the respective portions of the decorative layer A. That is, the above-described series of processes performed to generate the control data corresponds to a step of setting the control conditions in association with the respective portions on the surface of the base material according to the setting contents regarding the tactile sensation.

The control conditions are set according to a rule defined in the above-described tactile sensation conversion look-up table. This rule is determined by reflecting the effect of the clear ink and the fine particles on the tactile sensation. That is, the control conditions are set in consideration of the influence of the clear ink and the fine particles on the tactile sensation.

More specifically, the unevenness degree changes according to the number of landings of the clear ink (strictly, the number of dots formed by the clear ink), and the unevenness degree is larger as the number of landings is greater. Therefore, as can be seen from FIG. 5, as a control condition for forming a pattern in which the unevenness degree is set to “large” (for example, the patterns P1, P5, and the like), a condition for jetting a larger amount of the clear ink is set. On the contrary, as a control condition for forming a pattern in which the unevenness degree is set to “small” (for example, the patterns P3, P7, and the like), a condition for jetting a smaller amount of the clear ink is set.

Explaining the above description from the viewpoint of the formation process of the decorative layer A, in forming the decorative layer A, the clear ink image D is formed so as to be superimposed on the color ink image C. Among the clear ink images D, as shown in FIGS. 6 and 7, in the portion corresponding to the pattern in which the unevenness degree is set to “large”, more dots of a highly stretched ink Ix and more dots of a low-stretched ink Iy are formed. On the contrary, as shown in FIG. 8, in the portion corresponding to the pattern in which the unevenness degree is set to “small”, fewer dots of each clear ink are formed.

FIGS. 6 to 8 are schematic cross-sectional views showing how each pattern is formed. Specifically, FIG. 6 shows the clear ink dots constituting the pattern P1, FIG. 7 shows the clear ink dots constituting the pattern P5, and FIG. 8 shows the clear ink dots constituting the pattern P3.

Next, with regard to the bendability, the bendability changes according to the landing amount of each of the highly stretched ink Ix and the low-stretched ink Iy, and as shown in FIG. 9, the bendability is larger as the proportion (ratio) of the highly stretched ink Ix is larger. Therefore, as can be seen from FIG. 5, as a control condition for forming a pattern in which the bendability is set to “large” (for example, the patterns P1 and the like), a condition for jetting the highly stretched ink Ix more than the low-stretched ink Iy is set. On the contrary, as a control condition for forming a pattern in which the bendability is set to “small” (for example, the patterns P5 and the like), a condition for jetting the low-stretched ink Iy more than the highly stretched ink Ix is set.

FIG. 9 is a diagram showing a relationship between the proportion of the highly stretched ink and the bendability of the decorative member.

Explaining the above description from the viewpoint of the formation process of the decorative layer A, among the clear ink images D, as shown in FIG. 6, in the portion corresponding to the pattern in which the bendability is set to “large”, dots of the highly stretched ink Ix are formed more than dots of the low-stretched ink Iy. On the contrary, as shown in FIG. 7, in the portion corresponding to the pattern in which the bendability is set to “small”, dots of the low-stretched ink Iy are formed more than dots of the highly stretched ink Ix.

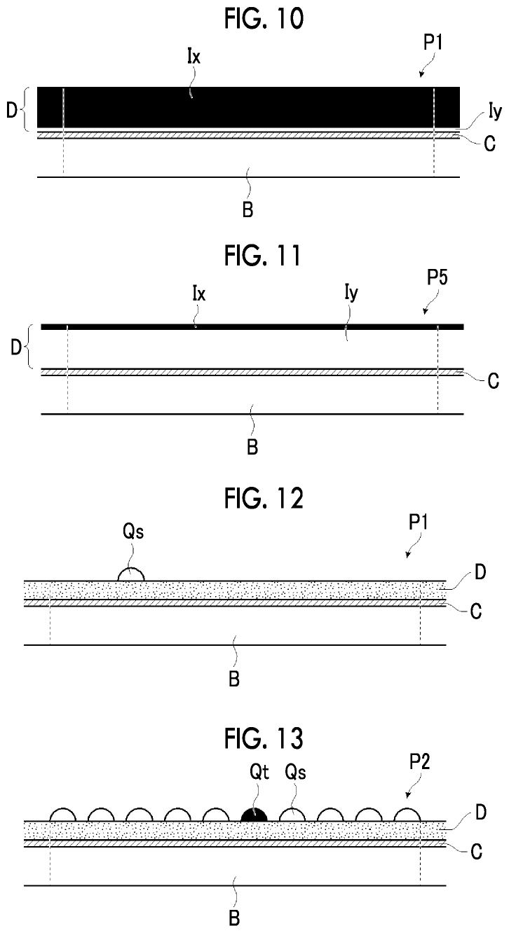

In addition, explaining another example of forming the patterns according to the bendability, as shown in FIGS. 10 and 11, the clear ink image D may be formed by laminating a layer of the highly stretched ink Ix and a layer of the low-stretched ink Iy. In this case, among the clear ink images D, as shown in FIG. 10, in the portion corresponding to the pattern in which the bendability is set to “large”, the layer of the highly stretched ink Ix is thicker than the layer of the low-stretched ink Iy. On the contrary, as shown in FIG. 11, in the portion corresponding to the pattern in which the bendability is set to “small”, the layer of the low-stretched ink Iy is thicker than the layer of the highly stretched ink Ix.

FIGS. 10 and 11 are schematic cross-sectional views showing how each pattern is formed. Specifically, FIG. 10 shows the layer of the clear ink constituting the pattern P1, and FIG. 11 shows the layer of the clear ink constituting the pattern P5.

Next, with regard to the magnitude of friction, the magnitude of friction changes according to the type and amount of the fine particles adhering to the clear ink. Specifically, the exposed portion on the surface of the clear ink is wider as the adhesion amount of the fine particles is smaller, so that the magnitude of friction is larger. In addition, among the fine particles adhered, the magnitude of friction is smaller as the ratio of the polyethylene particles having a lower friction coefficient is greater, and on the contrary, the magnitude of friction is larger as the ratio of the acrylic particles having a higher friction coefficient is greater. In consideration of the above description, as can be seen from FIG. 5, as a control condition for forming a pattern in which the magnitude of friction is set to “large” (for example, the patterns P1 and the like), a condition in which the scatter amount of each of the polyethylene particles and the acrylic particles is relatively small is set.

In addition, as a control condition for forming a pattern in which the magnitude of friction is set to “small” (for example, the patterns P2 and the like), a condition is set such that the scatter amount of the fine particles is relatively large and the ratio of the polyethylene particles is large. Furthermore, as a control condition for forming a pattern in which the magnitude of friction is set to “medium” (for example, the patterns P6 and the like), a condition is set such that the scatter amount of the fine particles is relatively large and the ratio of the acrylic particles is large.

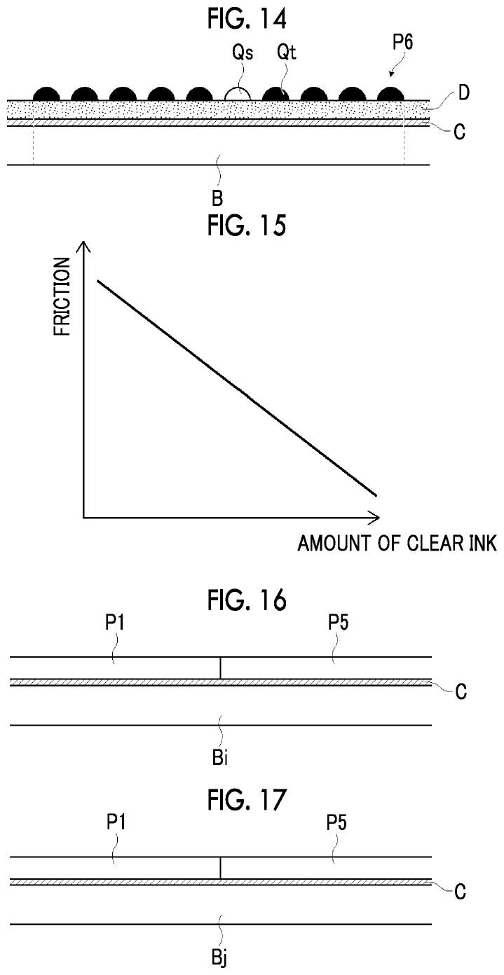

Explaining the above description from the viewpoint of the formation process of the decorative layer A, in forming the decorative layer A, the fine particles adhere to the clear ink image D. Among the clear ink images D, as shown in FIG. 12, in the portion corresponding to the pattern in which the magnitude of friction is set to “large”, the adhesion amounts of each of polyethylene particles Qs and acrylic particles Qt are relatively small. In addition, as shown in FIG. 13, in the portion corresponding to the pattern in which the magnitude of friction is set to “small”, the adhesion amount of the fine particles is relatively large and the ratio of the polyethylene particles Qs is greater than the ratio of the acrylic particles Qt. In addition, as shown in FIG. 14, in the portion corresponding to the pattern in which the magnitude of friction is set to “medium”, the adhesion amount of the fine particles is relatively large and the ratio of the acrylic particles Qt is greater than the ratio of the polyethylene particles Qs.

FIGS. 12 to 14 are schematic cross-sectional views showing how each pattern is formed. Specifically, FIG. 12 shows fine particles adhering to the clear ink in the pattern P1, FIG. 13 shows fine particles adhering to the clear ink in the pattern P2, and FIG. 14 shows fine particles adhering to the clear ink in the pattern P6.

Additionally, with regard to the control condition set according to the magnitude of friction, the jet amount of the clear ink may be set as a control condition according to the magnitude of friction, in addition to setting the type and scatter amount of the fine particle as control conditions as described above. More specifically, as shown in FIG. 15, as the amount of semi-cured clear ink on the respective portions on the surface of the base material increases, the adhesion amount of the fine particles to that portion tends to increase. Based on this, as a control condition for forming a pattern so that the magnitude of friction is a set magnitude, it is possible to set a condition so that the landing amount of the clear ink (strictly, amount of clear ink in a semi-cured state) is an amount corresponding to a set value of the magnitude of friction.

FIG. 15 is a diagram showing a relationship between the landing amount of the clear ink and the magnitude of friction on the surface of the decorative layer.

[Operation Example of Decorative Member Manufacturing Apparatus]

Next, as an operation example of the decorative member manufacturing apparatus 10 configured as described above, a manufacturing flow of the decorative member will be described. Hereinafter, a flow of manufacturing the decorative member Wd having the decorative layer A shown in FIG. 4 (that is, decorative layer A constituted of the eight types of the patterns P1 to P8) will be described as an example.

In starting the manufacturing flow of the decorative member, the user starts the application program for manufacturing a decorative member. In the above-described program, the user sets the tactile sensation for each of the eight types of the patterns P1 to P8. In addition, after setting the tactile sensation of each of the patterns P1 to P8, the user assigns any one of the eight types of patterns P1 to P8 to each of the plurality of portions (rectangular portions) constituting the decorative layer A.

Thereafter, the print data generator 31 and control data generator 32 of the host computer 30 generate print data and control data according to the above-described procedure. At this time, the control data generator 32 generates the control data for forming the patterns P1 to P8 of the decorative layer A based on the set control conditions for each pattern. That is, the control data generator 32 sets the control conditions of the patterns P1 to P8 according to the setting contents regarding the tactile sensation of the patterns P1 to P8, and generates the control data that the tactile sensation in an image-wise manner according to the patterns.

In a case where the generation of the print data and the control data is completed, the data transmitter 33 of the host computer 30 transmits the print data and the control data to the inkjet printer 20 together with the manufacturing instruction of the decorative member. In a case where various data are received from the host computer 30, the control part 26 of the inkjet printer 20 controls each part of the inkjet printer 20. Specifically, the moving mechanism 21 causes the base material B to move along the moving direction, and in a case where the base material B reaches the first position, the control part 26 performs the jetting step of various inks by the jetting part 22 according to the print data and the control data. In this jetting step, the color ink is jetted toward the respective portions of the surface of the base material based on the print data, so that the color ink image C is formed on the surface of the base material.

In addition, in the jetting step, the clear ink is jetted toward the respective portions of the surface of the base material based on the control data, so that the clear ink image D is formed while being superimposed on the color ink image C. At this time, the control part 26 controls the jetting part 22 so as to form the patterns P1 to P8 depending on the control conditions set according to the setting contents regarding the tactile sensation of each of the patterns P1 to P8. Specifically, the control part 26 controls the jetting part 22 such that the clear ink of the type and amount which are set for each pattern according to the setting content regarding the tactile sensation lands on the respective portions of the surface of the base material.

More specifically, the control part 26 controls the jetting part 22 such that the amounts of the highly stretched ink and the low-stretched ink, which are set for each pattern according to the setting content regarding the bendability and the unevenness degree, are respectively landed on the respective portions of the surface of the base material. That is, the type and amount of the clear ink to be landed on the surface of the base material is image-wise controlled according to the respective portions of the surface of the base material. As a result, the clear ink lands on the respective portions of the surface of the base material to form the clear ink image D, so that each portion of the clear ink image D satisfies the setting contents regarding the bendability and the unevenness degree.

After jetting the clear ink, the control part 26 controls the semi-curing part 23 to irradiate ultraviolet rays from the semi-curing part 23. As a result, the clear ink dots which have landed on the respective portions on the surface of the base material are in a semi-cured state.

In a case where the base material B reaches the second position due to the further movement of the base material B, the control part 26 performs the step of scattering the fine particles by the scattering part 24 according to the control data. In this scattering step, the fine particles are scattered (strictly, sprayed) to the respective portions of the surface of the base material, and adhere to the clear ink dots existing in a semi-cured state at the respective portions. At this time, the control part 26 controls the scattering part 24 such that the type and amount of the fine particles, which are set for each pattern according to the setting content regarding the tactile sensation, adhere to the semi-cured clear ink dots at the respective portions on the surface of the base material.

More specifically, the control part 26 controls the scattering part 24 such that the amounts of the polyethylene particles and the acrylic particles, which are set for each pattern according to the setting content regarding the magnitude of friction, respectively adhere to the clear ink dots at the respective portions on the surface of the base material. That is, the type and amount of the fine particles to be adhered to the clear ink dots is image-wise controlled according to the respective portions of the surface of the base material. As a result, various fine particles adhere to the clear ink dots at the respective portions on the surface of the base material, so that each of the patterns P1 to P8 of the decorative layer A satisfies the setting contents regarding the magnitude of friction.

In the present manufacturing flow, the type and amount of the fine particles scattered are controlled such that the magnitude of friction satisfies the setting content, but the present invention is not limited thereto. More specifically, the magnitude of friction changes according to the adhesion amount of the fine particles, and as shown in FIG. 15 described above, the adhesion amount of the fine particles increases as the amount of clear ink in a semi-cured state at the respective portions on the surface of the base material increases. Based on this, the control part 26 may control the jetting part 22 and the semi-curing part 23 such that the amount of clear ink in a semi-cured state at the respective portions on the surface of the base material is an amount set in association with the respective portions on the surface of the base material according to the setting content regarding the magnitude of friction. More specifically, the control part 26 may control the jetting part 22 and the semi-curing part 23 such that, as a portion has a larger magnitude of friction, the amount of clear ink in a semi-cured state at that portion increases.

After scattering the fine particles, the control part 26 controls the main curing part 25 to irradiate ultraviolet rays from the main curing part 25. As a result, the clear ink dots to which the fine particle adhere are cured to the main-curing state. At this point, on the respective portions on the surface of the base material, patterns having types assigned to that portion are formed.

Through the series of steps up to the above, the decorative layer A is formed on the surface of the base material, and the decorative member Wd is completed. The completed decorative member Wd moves to the exhaust port of the inkjet printer 20 by the moving mechanism 21, and then is exhausted from the exhaust port.

In the completed decorative member Wd, the tactile sensation (specifically, the bendability, the unevenness degree, and the magnitude of friction) of each of the patterns P1 to P8 of the decorative layer A are different for each pattern. That is, according to the above-described manufacturing flow, the tactile sensation of the respective portions of the decorative member Wd can be adjusted image-wise according to the position of the respective portions.

As described above, according to the decorative member manufacturing apparatus and method for manufacturing a decorative member according to the embodiment of the present invention, it is possible to adjust the tactile sensation in each portion of the decorative layer image-wise so as to have a desired tactile sensation. In particular, in the above-described embodiment, it is possible to simultaneously adjust the bendability, unevenness degree, and magnitude of friction as tactile sensations. In the above points, the decorative member manufacturing apparatus and method for manufacturing a decorative member according to the embodiment of the present invention are advantageous as compared with the prior art including the techniques disclosed in JP5391494B and JP5620613B.

More specifically, as described in the section of “SUMMARY OF THE INVENTION”, in the image forming apparatus disclosed in JP5391494B, how to adjust the texture in each portion of the decorative layer is not determined, and it is unclear whether the final texture will have what kind of tactile sensation. In addition, in the surface decoration film disclosed in JP5620613B, the surface roughness and the like of the surface decorative layer is adjusted within a predetermined numerical range, but it is not adjusted image-wise. In addition, it is unclear what kind of tactile sensation will be finally realized by adjusting the surface roughness.

On the other hand, in the decorative member manufacturing apparatus and method for manufacturing a decorative member according to the embodiment of the present invention, setting regarding the tactile sensation of the decorative member is performed for the respective portions on the surface of the base material, and control condition according to the setting content is set in association with the respective portions on the surface of the base material. The control part 26 controls the jetting part 22 and the scattering part 24 according to the above-described control condition. As a result, the tactile sensation at each portion of the decorative member is adjusted image-wise in association with the respective portions on the surface of the base material, such that the tactile sensation at each portion of the decorative member has a desired tactile sensation (specifically, a preset tactile sensation).

As described above, in the decorative member manufacturing apparatus and method for manufacturing a decorative member according to the embodiment of the present invention, the setting content regarding the tactile sensation of the decorative member is satisfied and the tactile sensation can be adjusted image-wise, and in this respect, it is advantageous as compared with the techniques disclosed in JP5391494B and JP5620613B.

In addition, according to the decorative member manufacturing apparatus and method for manufacturing a decorative member according to the embodiment of the present invention, since it is not necessary to prepare a plate for each ink as in analog printing, it is possible to perform image-wise tactile sensation control relatively easily and inexpensively.

[First Modification Example of Decorative Member Manufacturing Apparatus]

In the above-described embodiment, in a case of manufacturing the decorative member, the base material B is determined to move in one direction from the upstream side to the downstream side along the moving direction inside the inkjet printer 20. However, the present invention is not limited thereto, and a configuration (hereinafter, referred to as a “first modification example”) in which the base material B reciprocates between the first position and the second position in the moving path is also conceivable. Hereinafter, a decorative member manufacturing apparatus according to the first modification example will be described. Hereinafter, in the first modification example, the points different from the above-described embodiment will be mainly described.

In the first modification example, the moving mechanism 21 causes the base material B to reciprocate between the first position and the second position. In addition, in the modification example, the following steps are repeated multiple times, a jetting step in which the jetting part 22 jets various inks; a semi-curing step in which the clear ink is semi-cured by the semi-curing part 23; a first moving step in which the moving mechanism 21 causes the base material B to move from the first position to the second position, a scattering step in which the scattering part 24 scatters the fine particles; a main curing step in which the clear ink is main-cured by the main curing part 25; and a second moving step in which the moving mechanism 21 causes the base material B to return from the second position to the first position. Here, the jetting step and the semi-curing step are performed while the base material B is in the first position, and the first moving step is performed after the end of the jetting step and the semi-curing step in each time. The scattering step and the main curing step are performed while the base material B is in the second position, and the second moving step is performed after the end of the scattering step and the main curing step in each time. The main curing step may be performed while the base material B is in the first position.

That is, in the first modification example, the step of jetting and semi-curing the clear ink and the step of adhering the fine particles to the clear ink and main-curing the clear ink are alternately repeated multiple times. On the other hands, in the first modification example, after clear ink lands on a certain portion on the surface of the base material and the fine particles adhere to dots of the clear ink, clear ink lands on other portions on the surface of the base material and the fine particles adhere to dots of the clear ink.

In addition, in the first modification example, at each time of the multiple scattering steps, the control part 26 causes the scattering part 24 to scatter fine particles of a type and amount determined for each scattering step. More specifically, the control part 26 controls the scattering part 24 such that the type and amount of the fine particles adhering to the clear ink dots on the respective portions on the surface of the base material in the multiple scattering steps are a type and amount which set in association with the respective portions on the surface of the base material according to the setting content regarding the magnitude of friction. As a result, in each scattering step, the type and amount of the fine particles determined for each scattering step are scattered to the clear ink which has landed on the respective portions on the surface of the base material. Explaining the case where the decorative member Wd shown in FIG. 4 is manufactured as an example, in the portion of the decorative layer A corresponding to the pattern P4, for example, the polyethylene particles are scattered by “9” in the first scattering step and the acrylic particles are scattered by “1” in the second scattering step.

As desired above, even in the first modification example, it is possible to adjust the tactile sensation (specifically, the magnitude of friction) of the decorative member image-wise so as to obtain a desired tactile sensation.

[Second Modification Example of Decorative Member Manufacturing Apparatus]

In the above-described embodiment, it is possible to adjust the bendability, unevenness degree, and magnitude of friction as tactile sensations of the decorative member, but in addition to the above items, the temperature of the decorative layer may be further adjusted. That is, a configuration (hereinafter, referred to as a “second modification example”) in which the temperature of the decorative layer is adjusted image-wise according to the setting content thereof is conceivable. Hereinafter, a decorative member manufacturing apparatus according to the second modification example will be described. Hereinafter, in the second modification example, the points different from the above-described embodiment will be mainly described.

In the second modification example, in a case of setting the control condition, the temperature of each portion of the decorative layer is set, and specifically, any one of “high” or “low” is selected for the temperature of each portion of the decorative layer. Here, the temperature of each portion of the decorative layer is the warmth and coldness in a case where the surface of each portion of the decorative layer is touched. In addition, the temperature of the decorative layer changes depending on the type of the fine particles adhering to the clear ink.

In addition, in the second modification example, the scattering part 24 scatters a plurality of types of fine particles having different thermal conductivity from each other. The fine particles scattered by the scattering part 24 include acrylic particles having a higher thermal conductivity and polypropylene particles having a lower thermal conductivity. The thermal conductivity of the acrylic particles is 0.3 (W/mK).

The polypropylene particles are fine particles of a polypropylene-based resin, and the thermal conductivity thereof is 0.12 (W/mK). The polypropylene-based resin means a polyolefin in which the main component is a structural unit derived from propylene. Specific examples thereof include a propylene homopolymer, a propylene-ethylene random copolymer, a propylene-α-olefin random copolymer, a propylene-ethylene-α-olefin copolymer, a copolymer block including propylene as a main component, and a propylene-based block copolymer consisting of at least one of ethylene or α-olefin copolymer blocks and propylene. In addition, in a case where the polypropylene-based resin is a copolymer, the content of the structural unit derived from propylene with respect to all structural units in the copolymer is generally 70% to 99.9% by weight. In addition, the polypropylene-based resin may be used alone or in combination of two or more thereof.

The thermal conductivity is measured by, for example, the following measuring method described in JP2013-028501A.

(Measuring Method of Thermal Conductivity)

The central portion of Styrofoam having a length of 30 cm, a width of 30 cm, and a thickness of 5 cm is hollowed out into a square shape having a length of 24 cm and a width of 24 cm to form a frame of Styrofoam. An aluminum foil having a length of 30 cm and a width of 30 cm is attached to one side of the frame to form a recess, which serves as a sample table. The surface covered with the aluminum foil is a bottom surface of the sample table, and the other surface in the thickness direction of Styrofoam is a ceiling surface. After filling the recess with the fine particles, an aluminum foil having a length of 30 cm and a width of 30 cm is placed on the ceiling surface to obtain a measurement sample. Using the measurement sample, the thermal conductivity at 30° C. is measured using a heat flow meter HFM 436 Lambda (trade name, manufactured by NETZSCH).

In the second modification example, a control condition according to the setting content regarding the temperature of the decorative layer is set in association with the respective portions on the surface of the base material. More specifically, among fine particles adhered to the clear ink, the temperature of the decorative layer is lower as the ratio of the acrylic particles having a higher thermal conductivity is greater, and on the contrary, the temperature of the decorative layer is higher as the ratio of the polypropylene particles having a lower thermal conductivity is greater. Based on this, the control condition is set. Specifically explaining the case where the decorative layer A shown in FIG. 4 is formed as an example, in a case where the temperature at the pattern P1 is set to “low”, as a control condition for forming the pattern P1, a condition is set such that the ratio of the acrylic particles to the fine particles adhering to the clear ink dots in the pattern P1 is smaller than the ratio of the polypropylene particles.

Thereafter, the control part 26 controls the scattering part 24 according to the control condition set as described above. As a result, to the clear ink dots which have landed on the respective portions on the surface of the base material, the fine particles having the type set in association with the respective portions on the surface of the base material according to the setting content regarding the temperature of the decorative layer adhere.

With the above configuration, in the second modification example, it is possible to adjust the temperature in each portion of the decorative layer image-wise such that the temperature in each portion of the decorative layer is a desired temperature.

### Other Embodiments

The decorative member manufacturing apparatus and method for manufacturing a decorative member according to the embodiment of the present invention have been described above with an example, but the above-described embodiment is merely an example and other examples are also conceivable.

For example, in the above-described embodiment, in order to adjust the tactile sensation of the respective portions of the decorative member Wd image-wise according to the position of the respective portions, the control part 26 controls both the jetting part 22 and the scattering part 24. However, the present invention is not limited thereto, and any one of the jetting part 22 or the scattering part 24 may be controlled depending on a control condition set in association with the respective portions on the surface of the base material according to a setting content regarding tactile sensation. For example, in a case where only the unevenness degree is adjusted as the tactile sensation, the jetting part 22 may be controlled according to the setting content of the unevenness degree, and the scattering part 24 may be subjected to normal control (control not affected by the setting content of the tactile sensation).

In addition, in the above-described embodiment, the configuration of the decorative layer is controlled in order to adjust the tactile sensation of the decorative member, and specifically, the type and amount of the clear ink landing on the surface of the base material, and the type and amount of the fine particles adhering to the clear ink are controlled. Furthermore, in addition to such control, for example, in a case where a type of the base material B used for manufacturing the decorative member is changed, the tactile sensation of the decorative member can be changed according to the combination of the type of the base material B and the configuration of the decorative layer. For example, as shown in FIGS. 16 and 17, in a case where one base material is selected from a plurality of types of base materials B having different elasticity from each other, and the decorative layer A shown in FIG. 4 is formed on the surface of the selected base material B, the tactile sensation of respective portions of the decorative member is adjusted according to a combination of the type of the base material B and the decorative layer A.

FIGS. 16 and 17 are explanatory diagrams of tactile sensation control by the combination of the type of the base material B and the decorative layer A. In detail, FIG. 16 shows a case where a low elasticity base material Bi is used, and FIG. 17 shows a case where a high elasticity base material Bj is used.

Specifically explaining the tactile sensation control by the combination of the type of the base material B and the decorative layer A, as shown in FIG. 16, in a case where a pattern having a higher bendability (for example, the pattern P1) is formed on the low elasticity base material Bi, the elasticity is improved thereby, and in a case where a pattern having a smaller bendability (for example, the pattern P5) is formed on the low elasticity base material Bi, the elasticity is even lowered. On the contrary, as shown in FIG. 17, in a case where the pattern P1 having a higher bendability is formed on the high elasticity base material Bj, the elasticity is further improved, and in a case where the pattern P5 having a smaller bendability is formed on the high elasticity base material Bj, the elasticity can be intentionally reduced by that amount.

### EXPLANATION OF REFERENCES

10: decorative member manufacturing apparatus
20: inkjet printer
21: moving mechanism
22: jetting part
23: semi-curing part
24: scattering part
25: main curing part
26: control part
27A, 27B: platen
30: host computer
31: print data generator
32: control data generator
33: data transmitter
A: decorative layer
B: base material
Bi: low elasticity base material
Bj: high elasticity base material
C: color ink image
D: clear ink image
Ix: highly stretched ink
Iy: low-stretched ink
Qs: polyethylene particles
Qt: acrylic particles
Ny, Nm, Nc, Nk, Ng, Nh: nozzle
P1, P2, P3, P4, P5, P6, P7, P8: pattern
Wd: decorative member

What is claimed is:

1. A decorative member manufacturing apparatus for manufacturing a decorative member having a decorative layer formed on a surface of a base material, the decorative member manufacturing apparatus comprising:
a jetting part that jets a fluid toward respective portions of the surface of the base material to form the decorative layer, the fluid being cured by receiving light;
a scattering part that scatters fine particles to the fluid which has landed on the respective portions; and
a control part that controls the jetting part and the scattering part,
wherein the control part controls at least one of the jetting part or the scattering part depending on a control condition set in association with the respective portions according to a setting content regarding tactile sensation of the decorative member.

2. The decorative member manufacturing apparatus according to claim 1,
wherein the control part controls the jetting part such that the fluid of an amount which is set in association with the respective portions according to the setting content lands on the respective portions.

3. The decorative member manufacturing apparatus according to claim 2,
wherein the control part controls the jetting part such that the fluid of an amount which is set in association with the respective portions according to a setting content regarding an unevenness degree of the decorative layer lands on the respective portions.

4. The decorative member manufacturing apparatus according to claim 1,
wherein the control part controls the jetting part such that the fluid of a type which is set in association with the respective portions according to the setting content lands on the respective portions.

5. The decorative member manufacturing apparatus according to claim 4,
wherein a stretching ratio of the fluid in a cured state differs between fluids having different types from each other, and
the control part controls the jetting part such that the fluid of a type and amount which are set in association with the respective portions according to a setting content regarding a bendability of the decorative member and an unevenness degree of the decorative layer lands on the respective portions.

6. The decorative member manufacturing apparatus according to claim 1,
wherein the control part controls the scattering part such that the fine particles of an amount which is set in association with the respective portions according to a setting content regarding a magnitude of friction on a surface of the decorative layer adhere to the fluid which has landed on the respective portions.

7. The decorative member manufacturing apparatus according to claim 6, further comprising:
a semi-curing part that semi-cures the fluid by irradiating the fluid which has landed on the respective portions with light,
wherein the scattering part scatters the fine particles to the semi-cured fluid which has landed on the respective portions,
the amount of the fine particles in the respective portions increases as an amount of the semi-cured fluid in the respective portions increases, and
the control part controls the jetting part and the semi-curing part such that the amount of the semi-cured fluid in the respective portions is an amount set in association with the respective portions according to the setting content regarding the magnitude of friction.

8. The decorative member manufacturing apparatus according to claim 6, further comprising:
a main curing part that irradiates the fluid which has landed on the respective portions with light to main-cure the fluid; and
a moving mechanism for moving the base material between a first position where the surface of the base material faces the jetting part and a second position where the surface of the base material faces the scattering part,
wherein the flowing steps are repeated multiple times to form the decorative layer,
a jetting step in which the jetting part jets the fluid toward the surface of the base material while the base material is in the first position,
a first moving step in which the moving mechanism causes the base material to move from the first position to the second position,
a scattering step in which the scattering part scatters the fine particles to the fluid while the base material is in the second position,
a main curing step in which the main curing part irradiates the fluid with light to main-cure the fluid while the base material is in the second position, and
a second moving step in which the moving mechanism causes the base material to return from the second position to the first position.

9. The decorative member manufacturing apparatus according to claim 8,
wherein, in each time of the scattering steps, the control part causes the scattering part to scatter the fine particles of an amount determined for each time of the scattering steps, such that the amount of the fine particles adhering to the fluid which has landed on the respective portions in multiple times of the scattering steps is an amount set in association with the respective portions according to the setting content regarding the magnitude of friction.

10. The decorative member manufacturing apparatus according to claim 8,
wherein, in each time of the scattering steps, the control part causes the scattering part to scatter the fine particles to the fluid which has landed on the respective portions, the fine particles of a type set in association with the respective portions according to the setting content regarding the magnitude of friction, and
a friction coefficient of the fine particles differs between fine particles having different types from each other.

11. The decorative member manufacturing apparatus according to claim 1,
wherein the control part controls the scattering part such that the fine particles of a type set in association with the respective portions according to a setting content regarding a temperature of the decorative layer, adhere to the fluid which has landed on the surface of the base material, and
a thermal conductivity of the fine particles differs between fine particles having different types from each other.

12. A method for manufacturing a decorative member having a decorative layer formed on a surface of a base material, the method comprising:
a step of jetting, by a jetting part, a fluid toward respective portions of the surface of the base material to form the decorative layer, the fluid being cured by receiving light;
a step of scattering, by a scattering part, fine particles to the fluid which has landed on the respective portions; and
a step of setting a control condition in a case of controlling, by a control part, at least one of the jetting part or the scattering part in association with the respective portions according to a setting content regarding tactile sensation of the decorative member.
